(19) United States
(12) Patent Application Publication
(10) Pub. No.: US 2025/0350374 A1
(43) Pub. Date: Nov. 13, 2025

(54) OPTICAL POWER FEEDING SYSTEM AND POWER SOURCING EQUIPMENT

(71) Applicant: KYOCERA Corporation, Kyoto-shi, Kyoto (JP)

(72) Inventors: Shinji TSUDA, Katsushika-ku, Tokyo (JP); Takashi IWASAKI, Machida-shi, Tokyo (JP); Yoshiyuki KIMURA, Yokohama-shi, Kanagawa (JP); Takahiro ISHII, Yokohama-shi, Kanagawa (JP)

(21) Appl. No.: 18/873,482

(22) PCT Filed: Jun. 1, 2023
(86) PCT No.: PCT/JP2023/020478

§ 371 Date: Dec. 10, 2024

(30) Foreign Application Priority Data
Jun. 10, 2022 (JP) 2022-094044

(51) Int. Cl. H04B 10/80; H02J 50/30

(52) U.S. Cl. CPC H04B 10/807; H02J 50/30

(57) ABSTRACT

To suppress an influence of radiation of feed light subjected to spatial transmission, in an optical power feeding system 1B for power feeding from PSE 110B to a PD 310 by spatial transmission of feed light 112, the PSE 110B includes a light emitter 111 configured to output the feed light 112, the PD 310 includes a light receiver 311 configured to convert the feed light 112 that has been received into electric power, and the optical power feeding system 1B includes a surrounding member 150B surrounding a transmission path of the feed light 112 from the light emitter 111 to the light receiver 311. When the surrounding member 150B is a tubular body inside which the transmission path of the feed light 112 passes, a cleaning device 161 configured to clean gas in the surrounding member 150B or a pressure reducing device 171 configured to reduce a pressure in the surrounding member 150B may be provided.

### TECHNICAL FIELD

The present disclosure relates to an optical power feeding system and power sourcing equipment.

### BACKGROUND OF INVENTION

Recently, an optical power feeding system has been studied in which electric power is converted into light (called feed light), the feed light is transmitted and is converted into electric energy, and the electric energy is used as electric power.

In view of a possible damage caused by irradiation of an external object with high-power feed light, an optical power feeding system of the related art that performs spatial transmission provides measures by a configuration below.

The optical power feeding system of the related art has measures in which a magnitude of a loss is determined by comparison between radiation power emitted by a laser power transmitting device and radiation power received by a powered device, and output of the laser power transmitting device is limited when an abnormality is determined based on the magnitude of the loss (for example, see Patent Literature 1).

### CITATION LIST

### Patent Literature

Patent Literature 1: International Publication No. 2014/156465

### SUMMARY

### Problem to Be Solved

However, the above-described optical power feeding system of the related art is based on the premise that a decrease in radiation power caused at the powered device by irradiation of an external object with feed light is to be detected. Thus, the optical power feeding system of the related art has an issue that irradiation of the external object with the feed light to some extent is inevitable.

The present disclosure implements avoidance or suppression of irradiation of an external object with feed light subjected to spatial transmission.

### Solution to Problem

An optical power feeding system according to the present disclosure is
an optical power feeding system for power feeding from power sourcing equipment to a powered device by spatial transmission of feed light.

The power sourcing equipment includes a light emitter. The light emitter outputs the feed light.

The powered device includes a light receiver. The light receiver converts the feed light that has been received into electric power.

The optical power feeding system includes a surrounding member. The surrounding member surrounds a transmission path of the feed light from the light emitter to the light receiver.

Power sourcing equipment according to the present disclosure is
power sourcing equipment for power feeding to a powered device by spatial transmission of feed light through inside of a surrounding member. The inside serves as a transmission path. The surrounding member is a tubular body.

The power sourcing equipment includes a light emitter, a pressure reducing device, and a pressure detector. The light emitter outputs the feed light. The pressure reducing device removes air in the surrounding member. The pressure detector detects a pressure in the surrounding member.

When the pressure in the surrounding member does not reach a specified value or less as a result of pressure reduction by the pressure reducing device, outputting of the feed light is suppressed.

### BRIEF DESCRIPTION OF THE DRAWINGS

FIG. 1 is a configuration diagram of an optical power feeding system according to a first embodiment of the present disclosure.

FIG. 2 is a configuration diagram of an optical power feeding system according to a second embodiment of the present disclosure.

FIG. 3 is a configuration diagram of an optical power feeding system according to a third embodiment of the present disclosure.

FIG. 4 is a configuration diagram of an optical power feeding system according to a fourth or fifth embodiment of the present disclosure.

FIG. 5 is a configuration diagram of an optical power feeding system according to a sixth embodiment of the present disclosure.

FIG. 6 is a configuration diagram of an optical power feeding system according to a seventh embodiment of the present disclosure.

FIG. 7 is a configuration diagram of an optical power feeding system according to an eighth embodiment of the present disclosure.

### DESCRIPTION OF EMBODIMENTS

An embodiment of the present disclosure is described below with reference to the drawings.

### (1) Overview of System

### First Embodiment

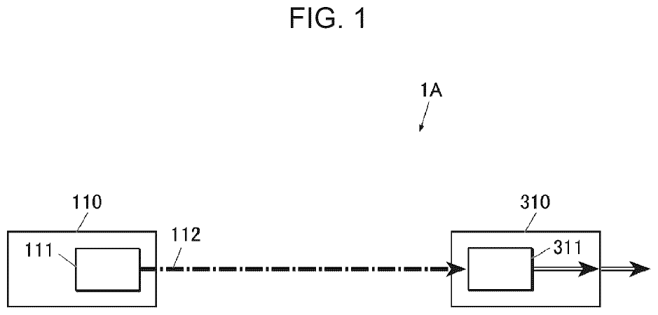

As illustrated in FIG. 1, an optical power feeding system 1A according to the present embodiment includes PSE (Power Sourcing Equipment) 110 and a PD (Powered Device) 310.

The PSE 110 converts electric power into optical energy, and supplies the optical energy. The PD 310 receives the supplied optical energy, and converts the optical energy into electric power.

To cope with an energy loss due to transmission through an optical fiber, the optical power feeding system 1A performs power feeding from the PSE 110 to the PD 310 by spatial transmission of feed light. Such an optical power feeding method is called PoA (Power over Air). Note that the spatial transmission herein indicates that feed light is transmitted with no optical fiber being arranged but only a space being present in a spatial transmission section between the PSE 110 and the PD 310.

Note that in individual embodiments including the present embodiment, an optical element for changing the direction of the feed light may be arranged in the spatial transmission section. However, a ratio of a path length of the optical element to a path length of the transmission path is to be in a minimum range for ensuring the function of changing the direction. The space in which the feed light is transmitted may be a vacuum, or air or another gas may be present in the space. Each embodiment described below exemplifies a case where the atmosphere is present between the PSE and the PD unless otherwise noted.

The entire transmission path of feed light 112 between the PSE 110 and the PD 310 need not be the spatial transmission section. For example, a part of the transmission path may be formed by an optical fiber, and the remaining part may be a spatial transmission path. However, each embodiment described below exemplifies a case where the entire transmission path of the feed light between the PSE and the PD is the spatial transmission section unless otherwise noted.

The PSE 110 includes a semiconductor laser device 111 for power feeding that serves as a light emitter.

The PSE 110 is connected to a power source, and the semiconductor laser device 111 for power feeding and so on are electrically driven.

The semiconductor laser device 111 for power feeding uses electric power from the power source to perform laser oscillation and output the feed light 112.

The feed light 112 from the PSE 110 propagates in the air, and is input to the PD 310.

The PD 310 includes a photoelectric conversion element 311 that serves as a light receiver.

The photoelectric conversion element 311 converts the feed light 112 transmitted in the air into electric power. The electric power obtained by the photoelectric conversion element 311 through the conversion is used as driving electric power needed in the PD 310. The PD 310 can also output, for an external device, the electric power obtained by the photoelectric conversion element 311 through the conversion.

Semiconductor materials of semiconductor regions that exhibit a light-electricity conversion effect of the semiconductor laser device 111 for power feeding and the photoelectric conversion element 311 are semiconductors having a short laser wavelength of 500 nm or shorter.

The semiconductors having a short laser wavelength have a large band gap and a high photoelectric conversion efficiency. Thus, the photoelectric conversion efficiency on the power-generating side and the powered side of optical power feeding increases, and consequently the optical power feeding efficiency increases.

Therefore, the semiconductor materials to be used may be, for example, semiconductor materials that are laser media of a laser wavelength (fundamental wave) of 200 to 500 nm such as diamond, gallium oxide, aluminum nitride, and gallium nitride.

The semiconductor materials to be used may be semiconductors having a band gap of 2.4 eV or greater.

For example, semiconductor materials that are laser media of a band gap of 2.4 to 6.2 eV such as diamond, gallium oxide, aluminum nitride, and gallium nitride may be used.

Laser light of a longer wavelength tends to have a higher transmission efficiency. Laser light of a shorter wavelength tends to have a higher photoelectric conversion efficiency. Thus, for long-distance transmission, a semiconductor material that is a laser medium for a laser wavelength (fundamental wave) longer than 500 nm may be used. When the photoelectric conversion efficiency is prioritized, a semiconductor material that is a laser medium for a laser wavelength (fundamental wave) shorter than 200 nm may be used.

These semiconductor materials may be used in either the semiconductor laser device 111 for power feeding or the photoelectric conversion element 311. The photoelectric conversion efficiency increases on the power-sourcing side or the powered side, and consequently the optical power feeding efficiency increases.

As described above, the optical power feeding system 1A performs spatial transmission using the space instead of using an optical fiber as the transmission path of the feed light 112. In general, the loss is about 30 [dB/km] when an optical fiber is used as the transmission path of the feed light 112. In contrast, the loss can be decreased to about 1 [dB/km] in spatial transmission.

When the semiconductor material of the semiconductor region that exhibits a light-electricity conversion effect of the semiconductor laser device 111 for power feeding is a semiconductor having a short laser wavelength of 500 nm or shorter, more specifically, when a semiconductor material that is a laser medium for a laser wavelength (fundamental wave) of 200 to 500 nm such as diamond, gallium oxide, aluminum nitride, or gallium nitride is used, the loss due to the optical fiber tends to occur in accordance with the length of the transmission distance, whereas the loss can be markedly decreased in spatial transmission.

The optical power feeding system 1A performs spatial transmission using a space instead of using an optical fiber as the transmission path of the feed light 112. Since no limitation of handling power defined for the optical fiber is applied, the feed light 112 can be output with a large output and larger electric power can be supplied via the PD 310.

### Second Embodiment

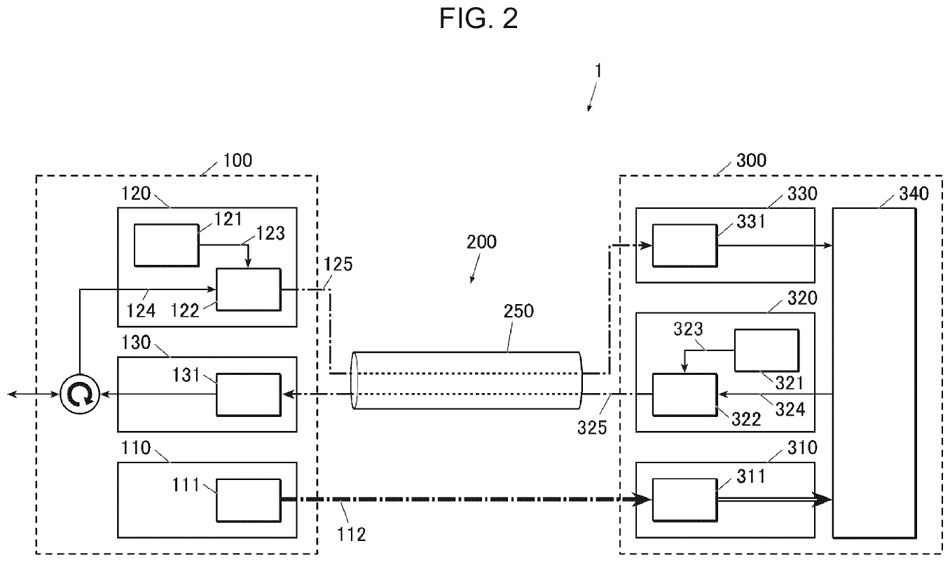

As illustrated in FIG. 2, an optical power feeding system 1 of the present embodiment includes a PoA (Power over Air) system that performs spatial transmission and an optical communication system. The optical power feeding system 1 includes a first data communication apparatus 100 including the PSE (Power Sourcing Equipment) 110, an optical fiber cable 200, and a second data communication apparatus 300 including the PD (Powered Device) 310.

The PSE 110 includes the semiconductor laser device 111 for power feeding. The first data communication apparatus 100 includes, in addition to the PSE 110, a transmitter 120 and a receiver 130 that perform data communication. The first data communication apparatus 100 corresponds to DTE (Data Terminal Equipment), a repeater, or the like. The transmitter 120 includes a semiconductor laser device 121 for signals and a modulator 122. The receiver 130 includes a photodiode 131 for signals.

The optical fiber cable 200 includes an optical fiber 250 that forms a channel of signal light.

The PD 310 includes the photoelectric conversion element 311. The second data communication apparatus 300 includes, in addition to the PD 310, a transmitter 320, a receiver 330, and a data processing unit 340. The second data communication apparatus 300 corresponds to a power end station or the like. The transmitter 320 includes a semiconductor laser device 321 for signals and a modulator 322. The receiver 330 includes a photodiode 331 for signals. The data processing unit 340 processes a received signal. The second data communication apparatus 300 is a node in a power feeding network. Alternatively, the second data communication apparatus 300 may be a node that communicates with another node.

The first data communication apparatus 100 is connected to a power source, and the semiconductor laser device 111 for power feeding, the semiconductor laser device 121 for signals, the modulator 122, the photodiode 131 for signals, and so on are electrically driven. The first data communication apparatus 100 is a node in the power feeding network. Alternatively, the first data communication apparatus 100 may be a node that communicates with another node.

The semiconductor laser device 111 for power feeding uses electric power from the power source to perform laser oscillation and output the feed light 112.

The photoelectric conversion element 311 converts the feed light 112 subjected to spatial transmission into electric power. The electric power obtained by the photoelectric conversion element 311 through the conversion is used as driving electric power for the transmitter 320, the receiver 330, and the data processing unit 340 and as other driving electric power needed in the second data communication apparatus 300. The second data communication apparatus 300 may also output, for an external device, the electric power obtained by the photoelectric conversion element 311 through the conversion.

On the other hand, the modulator 122 of the transmitter 120 modulates, based on transmission data 124, laser light 123 output from the semiconductor laser device 121 for signals into signal light 125, and outputs the signal light 125.

The photodiode 331 for signals of the receiver 330 demodulates the signal light 125 transmitted through the optical fiber cable 200 into an electric signal, and outputs the electric signal to the data processing unit 340. The data processing unit 340 transmits data based on the electric signal to a node. On the other hand, the data processing unit 340 receives data from the node, and outputs the data as transmission data 324 to the modulator 322.

The modulator 322 of the transmitter 320 modulates, based on the transmission data 324, laser light 323 output from the semiconductor laser device 321 for signals into signal light 325, and outputs the signal light 325.

The photodiode 131 for signals of the receiver 130 demodulates the signal light 325 transmitted through the optical fiber cable 200 into an electric signal, and outputs the electric signal. Data based on the electric signal is transmitted to a node. On the other hand, data from the node is treated as the transmission data 124.

### (2) Employment of Configuration for Avoiding Irradiation of External Object With Feed Light Subjected to Spatial Transmission

An optical power feeding system that employs a configuration for avoiding irradiation of an external object (foreign matter) with the feed light 112 subjected to spatial transmission is described.

In each embodiment described below, the same components as those in the first embodiment or the second embodiment are denoted by the same reference signs, and redundant description thereof is omitted.

### Third Embodiment

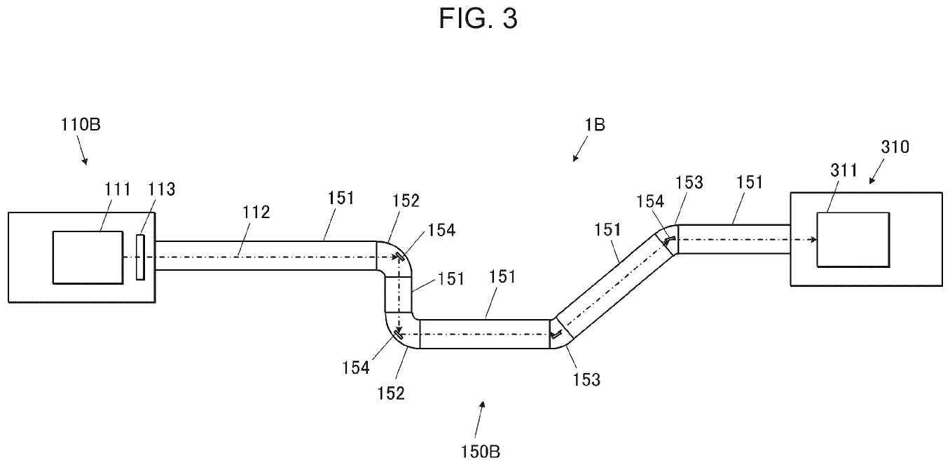

FIG. 3 is a configuration diagram illustrating an optical power feeding system 1B according to a third embodiment that employs a configuration for avoiding irradiation of an external object with the feed light 112 subjected to spatial transmission.

The optical power feeding system 1B of the third embodiment includes PSE 110B, the PD 310, and a surrounding member 150B.

The PSE 110B includes the semiconductor laser device 111 for power feeding, and an optical system 113 that collects the feed light 112 to avoid diffusion and collimates the feed light 112.

The optical system 113 includes, for example, a collimating lens. The optical system 113 may include multiple lenses.

The feed light 112 that is laser light emitted through the optical system 113 is incident onto the photoelectric conversion element 311 of the PD 310 along a predetermined transmission path without diffusion.

The surrounding member 150B is a conduit formed of a tubular body (for example, pipes) surrounding the entire transmission path of the feed light 112.

As illustrated in FIG. 3, the transmission path of the feed light 112 need not be formed by a single straight line. The PSE 110B and the PD 310 are not necessarily arranged on a single straight line. Therefore, a transmission path is formed in which the feed light 112 emitted to the front from the semiconductor laser device 111 for power feeding of the PSE 110B is perpendicularly incident on the photoelectric conversion element 311 of the PD 310 when the PSE 110B and the PD 310 are arranged in accordance with a use environment thereof. For example, the transmission path includes multiple straight lines connected to each other at one or more bent points.

The present embodiment exemplifies the surrounding member 150B surrounding the transmission path of the feed light 112 bent at multiple points. Note that the shapes of the transmission path and the surrounding member 150B illustrated in FIG. 3 are merely an example, and are not limited this example and may have any shapes. The transmission path and the surrounding member 150B are not limited to those developed on a plane as in the illustrated example, and may be developed three-dimensionally in a three-dimensional space.

The surrounding member 150B includes multiple straight pipes 151 through which the feed light 112 passes in a straight section of the transmission path, joints 152 and 153 coupling the straight pipes 151 to each other at bent portions of the transmission path, and multiple optical elements 154 that bend the feed light 112 at the respective bent portions of the transmission path.

The straight pipes 151 are straight circular pipes. The straight pipes 151 are arranged to let the feed light 112 (transmission path) pass through the center thereof. One end or both ends of each of the straight pipes 151 is or are coupled to the joint 152 or 153. Note that the cross-sectional shape of the straight pipes 151 is not limited to the circular shape, and may be any shape such as a square shape.

The joints 152 and 153 are curved pipes. Each of the joints 152 and 153 supports the optical element 154 in a fixed manner therein, and is coupled to the straight pipes 151 to let the feed light 112 (transmission path) before and after a bent position of the optical element 154 pass through the center at one end of the joint 152 or 153 and the center at the other end of the joint 152 or 153, respectively.

At least the one end and the other end of each of the joints 152 and 153 have an increased diameter to allow the straight pipes 151 to be inserted and coupled thereto.

The joints 152 have a 90-degree arc shape to deal with the feed light 112 (transmission path) bent by 90 degrees. The joints 153 have a 45-degree arc shape to deal with the feed light 112 (transmission path) bent by 45 degrees. Note that the bent angles of the transmission path are not limited to 90 degrees and 45 degrees, and may be any angles. Accordingly, the angles of the joints 152 and 153 may be any angles corresponding to the bent angles of the transmission path.

The optical element 154 is, for example, a total reflection mirror. The optical element 154 is supported in a fixed manner in the corresponding joint 152 or 153 with an orientation of a reflective surface being adjusted to implement the bent angles required for the transmission path.

The optical element 154 is not limited to a mirror that causes reflection, and may be another optical element that can change the direction of the feed light 112. For example, the optical element 154 may be an optical element, such as a prism, that changes the direction by refraction caused when the feed light 112 passes therethrough.

The straight pipes 151 and the joints 152 and 153 that form the surrounding member 150B may be made of a material which the feed light 112 does not pass through. At least inner surfaces of the straight pipes 151 and the joints 152 and 153 may be made of a material having a low absorptivity for the feed light 112. In this case, at least the inner surfaces of the straight pipes 151 and the joints 152 and 153 may be made of a material that reflects the feed light 112, and may be used as reflective surfaces.

In principle, the surrounding member 150B has a shape with which the feed light 112 passes through the centers of the straight pipes 151 and the joints 152 and 153 and the inner surfaces of the straight pipes 151 and the joints 152 and 153 are not irradiated with the feed light 112. However, when any portion of the optical power feeding system 1B or any portion of a structure in which the optical power feeding system 1B is installed receives an unexpected external force, the orientation of the PSE 110B or the PD 310 may change or the surrounding member 150B may be distorted.

In such a case, the inner surfaces of the straight pipes 151 and the joints 152 and 153 may be irradiated with the feed light 112. However, when the straight pipes 151 and the joints 152 and 153 are made of a material which the feed light 112 does not pass through, leakage of the feed light 112 to the outside can be suppressed.

When at least the inner surfaces of the straight pipes 151 and the joints 152 and 153 are made of a material that does not absorb the feed light 112 or a material that reflects the feed light 112, an influence, such as a damage, caused when the straight pipes 151 and the joints 152 and 153 are irradiated with the feed light 112 can be reduced or suppressed.

As described above, the optical power feeding system 1B includes the surrounding member 150B, and thus can effectively hinder a foreign matter from entering, from the outside, the transmission path of the feed light 112 subjected to spatial transmission from the PSE 110B to the PD 310 and effectively avoid or suppress irradiation of the external foreign matter with the feed light 112.

In particular, the surrounding member 150B is formed of a tubular body including pipes, and thus can surround the transmission path of the feed light 112 with a tube wall that does not allow gas to pass therethrough, more effectively hinder a foreign matter from entering the transmission path from the outside, and more effectively avoid or suppress irradiation of the external foreign matter with the feed light 112.

The surrounding member 150B formed of a tubular body including pipes has been exemplified. However, the surrounding member may be formed of a lattice-like skeleton, a protective fence, a mesh, or the like when the hermeticity is not required for the surrounding member (the hermeticity is required when a cleaning device 161 or a pressure reducing device 171 described later is provided). In such a case, the surrounding member has an opening, and thus cannot sufficiently hinder entry of a small foreign matter that can pass through the opening. However, the surrounding member can hinder entry of a foreign matter having a certain size, and thus can effectively avoid or suppress irradiation of the foreign matter with the feed light 112.

### Fourth Embodiment

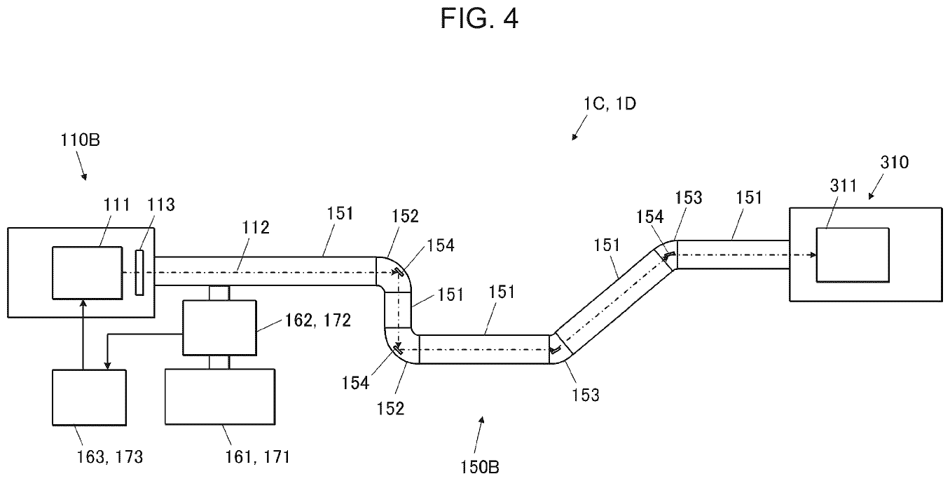

FIG. 4 is a configuration diagram illustrating an optical power feeding system 1C according to a fourth embodiment that employs a configuration for avoiding irradiation of an external object with the feed light 112 subjected to spatial transmission.

Note that the optical power feeding system 1C according to the fourth embodiment and an optical power feeding system 1D according to a fifth embodiment described later are different from each other in specific contents of the components but are common in arrangement of the components and the like. Thus, FIG. 4 presents reference signs for the optical power feeding system 1C and reference signs for the optical power feeding system 1D together for common use of the drawing.

In the fourth embodiment, the same components as those of the other embodiments already described are denoted by the same reference sings, and redundant description thereof is omitted.

The optical power feeding system 1C has a configuration in which the cleaning device 161 that cleans gas in the surrounding member 150B, a dust detector 162 that detects an amount of dust in the gas in the surrounding member 150B, and a control device 163 that causes the cleaning device 161 to operate until the detected amount of dust is equal to or less than a specified value are added to the configuration of the optical power feeding system 1B described above.

In the optical power feeding system 1C, coupling portions of the components of the surrounding member 150B may be sealed to make the entire internal space of the surrounding member 150B be a closed space. In this case, an end of the surrounding member 150B adjacent to the PSE 110B and an end of the surrounding member 150B adjacent to the PD 310 may be sealed and terminated with a material which the feed light 112 passes through. One end of the surrounding member 150B and a housing that stores the semiconductor laser device 111 for power feeding may be sealed and connected to each other. The other end of the surrounding member 150B and a housing that stores the photoelectric conversion element 311 may be sealed and connected to each other. Thus, the inside of the surrounding member 150B and the inside of the housings may be a closed space.

One end of the surrounding member 150B and an emission surface of the feed light 112 of the semiconductor laser device 111 for power feeding may be communicatively connected to each other by sealing. The other end of the surrounding member 150B and a light receiving surface of the photoelectric conversion element 311 may be communicatively connected to each other by sealing. Thus, the inside of the surrounding member 150B may be a closed space.

The cleaning device 161 is connected to the surrounding member 150B through a connection pipe communicating with the internal space of the surrounding member 150B. The connection pipe includes an introduction pipe that draws the gas in the internal space of the surrounding member 150B to the cleaning device 161, and a discharge pipe that returns the air cleaned along the cleaning device 161 to the internal space of the surrounding member 150B.

The cleaning device 161 includes a suction fan that draws air through the introduction pipe, and a dust collecting filter that collects dust such as dirt included in the air drawn through the introduction pipe.

The air that has passed through the dust collecting filter can be returned to the surrounding member 150B through the discharge pipe by the suction fan.

Note that the means for removing the dust from the air is not limited to the dust collecting filter, and may be another system, for example, a plasma dust collector, an electrostatic suction dust collector, or a combination of the dust collecting filter and any of these dust collectors.

The dust detector 162 is provided midway of the introduction pipe for the cleaning device 161. The dust detector 162 includes a light source that illuminates when the gas in the internal space of the surrounding member 150B drawn into the introduction pipe passes, and a light receiving element that detects light intensity of scattered light emitted by the dust included in the gas in the internal space of the surrounding member 150B due to illumination.

The dust detector 162 detects the amount of dust included in the gas in the internal space of the surrounding member 150B as the light intensity, and inputs the light intensity to the control device 163.

The control device 163 controls the cleaning device 161, and can switch the cleaning device 161 to operate and stop.

The control device 163 stores an allowable value of the amount of dust included in the gas in the internal space of the surrounding member 150B, and compares the allowable value with the detected amount of dust included in the gas in the internal space of the surrounding member 150B input from the dust detector 162. The control device 163 controls the cleaning device 161 to keep operating if the detected amount of dust is greater than the allowable value of the amount of dust. The control device 163 controls the cleaning device 161 to stop if the detected amount of dust is equal to or less than the allowable value of the amount of dust.

Note that the control device 163 described above may include a microcomputer, or a sequencer using an analog circuit or a digital circuit.

Note that the configuration is exemplified in which the cleaning device 161, the dust detector 162, and the control device 163 are arranged adjacently to the PSE 110B from which the power source is obtained easily. However, the arrangement is not limited to this configuration. The cleaning device 161, the dust detector 162, and the control device 163 may be arranged adjacently to the PD 310 to receive the power source from the PD 310.

The introduction pipe and the discharge pipe of the connection pipe for the cleaning device 161 may be connected to, for example, on the one end side and the other end side of the surrounding member 150B, respectively. In such a case, the internal gas circulates along the surrounding member 150B, and the entire inside of the surrounding member 150B can be effectively cleaned.

The optical power feeding system 1C includes the cleaning device 161 for the gas in the surrounding member 150B, and thus can remove or reduce the dust included in the gas in the internal space of the surrounding member 150B. The dust which is a cause of the loss that occurs in the semiconductor laser device 111 for power feeding is removed from the transmission path. This can decrease the loss and increase the power feeding efficiency in spatial transmission of the feed light 112.

In the optical power feeding system 1C, the control device 163 controls the cleaning device 161 to operate until the amount of dust detected by the dust detector 162 is equal to or less than the specified value. This enables, for example, control for reducing the loss that occurs in the semiconductor laser device 111 for power feeding to a target level, and enables power feeding at a target power feeding efficiency.

### Fifth Embodiment

FIG. 4 is a configuration diagram illustrating the optical power feeding system 1D according to the fifth embodiment that employs a configuration for avoiding irradiation of an external object with the feed light 112 subjected to spatial transmission.

In the fifth embodiment, the same components as those of the other embodiments already described are denoted by the same reference sings, and redundant description thereof is omitted.

The optical power feeding system 1D has a configuration in which the pressure reducing device 171 that reduces a pressure in the surrounding member 150B, a pressure detector 172 that detects the pressure in the surrounding member 150B, and a control device 173 that suppresses outputting of the feed light by the semiconductor laser device 111 for power feeding when the pressure detected by the pressure detector 172 during pressure reduction does not reach a specified value or less are added to the configuration of the optical power feeding system 1B described above.

As in the case of the optical power feeding system 1C, the transmission space in the surrounding member 150B is sealed to be a closed space in the optical power feeding system 1D.

The pressure reducing device 171 is connected to the surrounding member 150B through a connection pipe communicating with the internal space of the surrounding member 150B.

The pressure reducing device 171 is a so-called pressure reducing pump. The pressure reducing device 171 performs vacuuming in the surrounding member 150B through the connection pipe, and thus can reduce and remove the internal gas.

The pressure detector 172 is a so-called pressure sensor. The pressure detector 172 detects the pressure in the internal space of the surrounding member 150B, and inputs the pressure to the control device 173.

The control device 173 controls the pressure reducing device 171, and can switch the pressure reducing device 171 to operate and stop. The control device 173 also controls the semiconductor laser device 111 for power feeding, and can switch the feed light 112 to be output and stopped.

The control device 173 stores a target value of the pressure in the internal space of the surrounding member 150B, and compares the target value with the detected pressure in the internal space of the surrounding member 150B input from the pressure detector 172.

Upon the start of the operation of the pressure reducing device 171, the control device 173 starts measuring an elapsed time from the start of pressure reduction and monitors the pressure detected by the pressure detector 172.

As a result, when the detected pressure does not reduce to the target value of the pressure before the allowable elapsed time passes, the control device 173 determines that detachment or damage may be caused somewhere in the surrounding member 150B. If the semiconductor laser device 111 for power feeding is outputting the feed light 112, the control device 173 sets a stop state in which the output is stopped. If the semiconductor laser device 111 for power feeding is not outputting the feed light 112, the control device 173 sets a stop state in which the output is not started.

Note that if the semiconductor laser device 111 for power feeding is outputting the feed light 112, the control device 173 may perform processing of reducing the output. For example, the control device 173 may lower the output to a level that is safe even if the feed light 112 leaks out of the surrounding member 150B. If the semiconductor laser device 111 for power feeding is not outputting the feed light 112, the control device 173 may start outputting the feed light 112 at an output lower than usual. For example, the control device 173 may start outputting the feed light 112 at a level that is safe even if the feed light 112 leaks out of the surrounding member 150B.

The control device 173 may notify the outside that the pressure reduction has failed upon setting any one of the stop state and the output reduced state.

On the other hand, when the detected pressure is reduced to the target value of the pressure before the allowable elapsed time passes, the control device 173 stops the pressure reducing device 171 and starts outputting the feed light 112 from the semiconductor laser device 111 for power feeding.

The control device 173 sets a pressure slightly higher than the target value, as a target value for resuming pressure reduction. The control device 173 performs control to resume the operation of the pressure reducing device 171 when the pressure detected while the pressure reducing device 171 is stopped exceeds the target value for resuming pressure reduction.

When the operation of the pressure reducing device 171 is resumed, the control device 173 again starts measuring an elapsed time from when the pressure reduction is resumed, and determines whether the detected pressure is reduced to the target value of pressure before the allowable elapsed time passes and determines whether to continue or stop the output of the feed light 112.

Thus, during power feeding, the pressure in the internal space of the surrounding member 150B is constantly monitored, and is maintained between the target value and the target value for resuming pressure reduction.

Note that the control device 173 described above may include a microcomputer, or a sequencer using an analog circuit or a digital circuit.

Note that the configuration is exemplified in which the pressure reducing device 171, the pressure detector 172, and the control device 173 are arranged adjacently to the PSE 110B from which the power source is obtained easily. However, the arrangement is not limited to this configuration. The pressure reducing device 171, the pressure detector 172, and the control device 173 may be arranged adjacently to the PD 310 to receive the power source from the PD 310.

The optical power feeding system 1D includes the pressure reducing device 171 that reduces the pressure in the surrounding member 150B, and thus can reduce or remove the gas in the internal space of the surrounding member 150B. The gas which is a cause of the loss that occurs in the semiconductor laser device 111 for power feeding is reduced or removed from the transmission path. This can decrease the loss and increase the power feeding efficiency in spatial transmission of the feed light 112.

In the optical power feeding system 1D, the control device 173 performs control to set the stop state in which the output of the feed light 112 by the semiconductor laser device 111 for power feeding is stopped when the pressure in the surrounding member 150B detected by the pressure detector 172 is not reduced to the specified value during pressure reduction by the pressure reducing device 171. Thus, the output of the feed light 112 can be stopped when detachment or damage may be caused somewhere in the surrounding member 150B, and irradiation of a foreign matter that has entered the transmission path from the outside with the feed light 112 or irradiation of a foreign matter with the feed light 112 that has leaked from the surrounding member 150B can be effectively avoided or suppressed.

### Sixth Embodiment

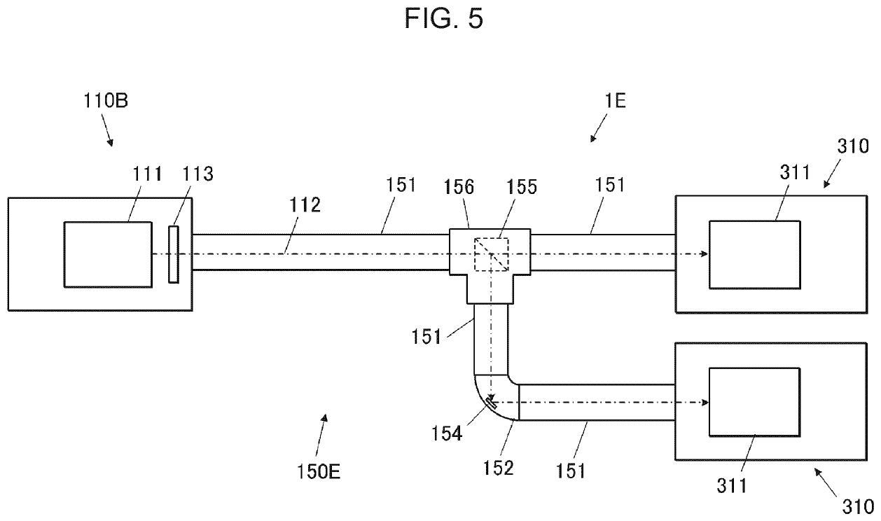

FIG. 5 is a configuration diagram illustrating an optical power feeding system 1E according to a sixth embodiment that employs a configuration for avoiding irradiation of an external object with the feed light 112 subjected to spatial transmission.

In the sixth embodiment, the same components as those of the other embodiments already described are denoted by the same reference sings, and redundant description thereof is omitted.

The optical power feeding system 1E has a configuration in which the transmission path of the feed light 112 branches and power feeding is performed to the multiple PDs 310. An example in which power feeding is performed to two PDs 310 is presented. However, the number of branches may be increased and power feeding may be performed to more PDs 310.

Part of the feed light 112 output from the PSE 110B to the front transmits through an optical element 155, which is a beam splitter, arranged midway and is incident onto one of the PDs 310. The remaining part is reflected and the direction thereof is bent by 90 degrees. The feed light 112 reflected by the optical element 155 is reflected again by the optical element 154, which is a total reflection mirror, so that the direction of the feed light 112 is bent by 90 degrees. The feed light 112 is then incident onto the other one of the PDs 310. Note that if no layout issue arises, the other one of the PDs 310 may receive the feed light 112 without via the optical element 154 which is the total reflection mirror.

A surrounding member 150E included in the optical power feeding system 1E has a structure surrounding the entire region of the feed light 112 that passes through the transmission path.

The surrounding member 150E includes two straight pipes 151 and a T-shaped joint 156. The two straight pipes 151 surround the feed light 112 that is output from the PSE 110B to the front, passes straight through the optical element 155, and is incident onto the one of the PDs 310. The T-shaped joint 156 couples the two straight pipes 151 to each other and supports the optical element 155 in a fixed manner therein.

The surrounding member 150E further includes one straight pipe 151 and an L-shaped joint 152. The straight pipe 151 is coupled to a branching end of the T-shaped joint 156 and surrounds the feed light 112 that is reflected by the optical element 155 and bent by 90 degrees in the direction. The L-shaped joint 152 is coupled to the straight pipe 151 and supports the optical element 154 in a fixed manner therein.

The surrounding member 150E further includes one straight pipe 151 surrounding the feed light 112 that is reflected by the optical element 154 and bent by 90 degrees in the direction. The straight pipe 151 is connected to the other one of the PDs 310.

Note that the branching transmission path of the feed light 112 is not limited to the form described above, and can have any shape in accordance with a desired arrangement of the PSE 110B and each PD 310. The shape of the surrounding member 150E can also be adjusted by combination of the straight pipes 151 and the joints 152, 153, and 156 in accordance with any shape of the transmission path of the feed light 112.

The optical power feeding system 1E may additionally include the cleaning device 161, the dust detector 162, and the control device 163 described above. Alternatively, the optical power feeding system 1E may additionally include the pressure reducing device 171, the pressure detector 172, and the control device 173.

Even when power feeding is performed from the PSE 110B to the multiple PDs 310, the optical power feeding system 1E can effectively hinder a foreign matter from entering, from the outside, the transmission path of the feed light 112 subjected to spatial transmission, and effectively avoid or suppress irradiation of the external foreign matter with the feed light 112.

### Seventh Embodiment

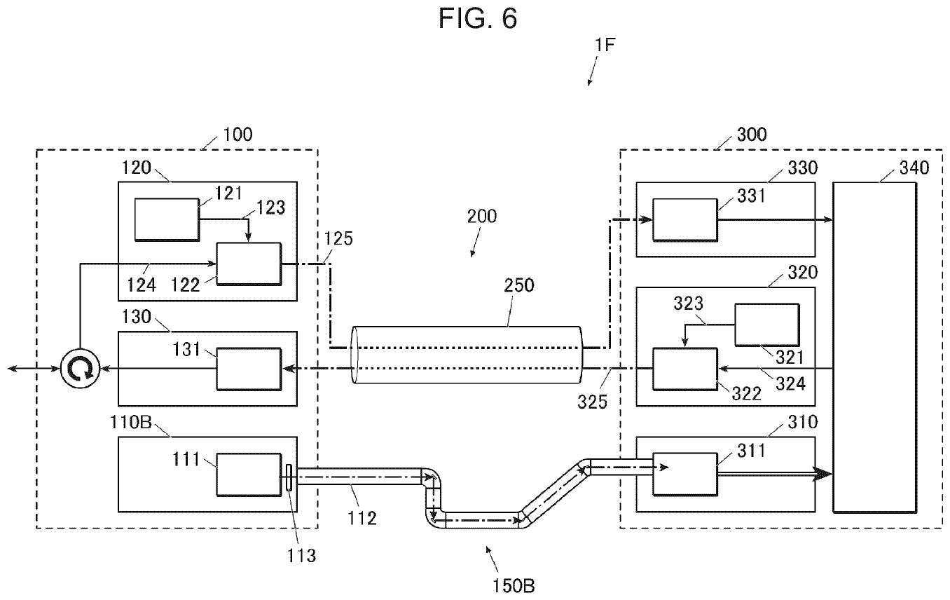

FIG. 6 is a configuration diagram illustrating an optical power feeding system 1F according to a seventh embodiment that employs a configuration for avoiding irradiation of an external object with the feed light 112 subjected to spatial transmission.

In the seventh embodiment, the same components as those of the other embodiments already described are denoted by the same reference sings, and redundant description thereof is omitted.

The optical power feeding system 1F has a configuration in which the optical power feeding system 1 of the second embodiment described above employs the surrounding member 150B.

Also in this optical power feeding system 1F, the surrounding member 150B can effectively hinder a foreign matter from entering, from the outside, the transmission path of the feed light 112 subjected to spatial transmission from the PSE 110B to the PD 310, and effectively avoid or suppress irradiation of the external foreign matter with the feed light 112.

In the optical power feeding system 1F, the signal light 125 and the signal light 325 (the laser light 123 and the laser light 323) subjected to data communication between the first data communication apparatus 100 and the second data communication apparatus 300 propagate through the optical fiber cable 200. However, spatial transmission of these light may be performed. In such a case, the surrounding member 150B may have an enlarged cross section and surround the propagation path of the signal light 125 and the signal light 325 along with the propagation path of the feed light 112. The optical power feeding system 1F may include, in addition to the surrounding member 150B, another surrounding member surrounding the propagation path of the signal light 125 and the signal light 325. Alternatively, the surrounding member may be individually provided for each of the signal light 125 and the signal light 325.

The optical power feeding system IF may additionally include the cleaning device 161, the dust detector 162, and the control device 163 described above. Alternatively, the optical power feeding system 1F may additionally include the pressure reducing device 171, the pressure detector 172, and the control device 173.

### Eighth Embodiment

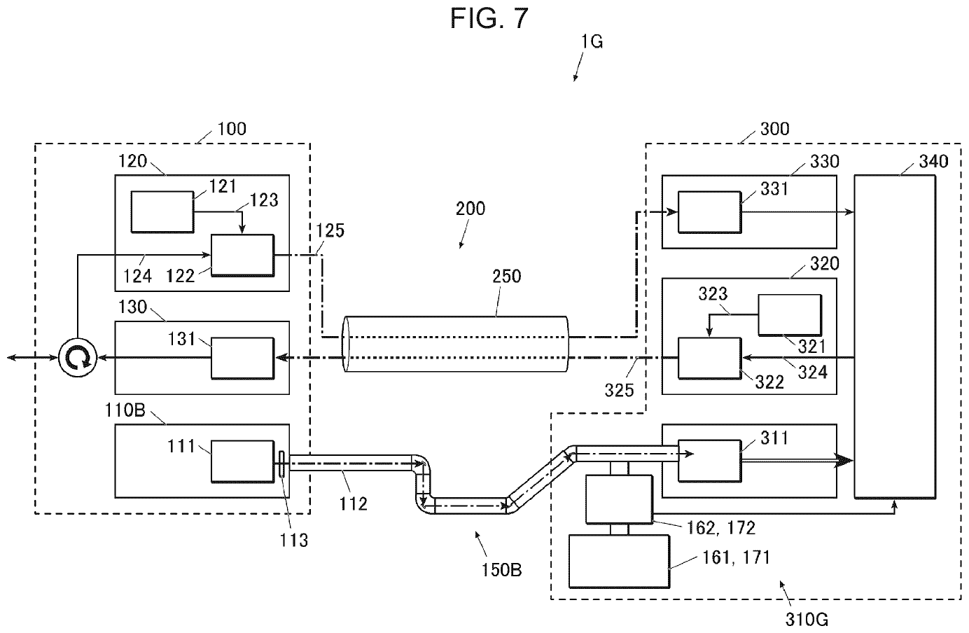

FIG. 7 is a configuration diagram illustrating an optical power feeding system 1G according to an eighth embodiment that employs a configuration for avoiding irradiation of an external object with the feed light 112 subjected to spatial transmission.

In the eighth embodiment, the same components as those of the other embodiments already described are denoted by the same reference sings, and redundant description thereof is omitted.

A PD 310G of the optical power feeding system 1G has a configuration in which the cleaning device 161 and the dust detector 162 described above are provided adjacently to the PD 310 of the optical power feeding system 1F of the seventh embodiment described above or a configuration in which the pressure reducing device 171 and the pressure detector 172 described above are provided adjacently to the PD 310 of the optical power feeding system 1F.

In this case, the cleaning device 161 and the dust detector 162, or the pressure reducing device 171 and the pressure detector 172 are supplied with electric power from the PD 310.

Instead of providing the control device 163 or 173 that controls the cleaning device 161 or the pressure reducing device 171, the data processing unit 340 executes the functions of the control device 163 or 173 by using the processing capability of the data processing unit 340.

However, the control device 163 or 173 may be included.

Also in the optical power feeding system 1G, the surrounding member 150B can effectively hinder a foreign matter from entering, from the outside, the transmission path of the feed light 112 subjected to spatial transmission from the PSE 110B to the PD 310, and effectively avoid or suppress irradiation of the external foreign matter with the feed light 112.

### Others

The embodiments of the present disclosure have been described above. However, the present disclosure is not limited to the embodiments described above.

For example, instead of using spatial transmission over the entire transmission path of the feed light 112, a part of the transmission path may be formed by an optical fiber, and spatial transmission may be performed in the remaining part.

In such a case, a surrounding member surrounding only the spatial transmission section may be provided.

An embodiment of the present disclosure is presented below. In an embodiment,
(1) An optical power feeding system performs power feeding from power sourcing equipment to a powered device by spatial transmission of feed light.

The power sourcing equipment includes a light emitter configured to output the feed light.

The powered device includes a light receiver configured to convert the feed light that has been received into electric power.

The optical power feeding system includes a surrounding member surrounding a transmission path of the feed light from the light emitter to the light receiver.
(2) In the optical power feeding system according to (1),
the surrounding member is a tubular body inside which the transmission path of the feed light passes.
(3) The optical power feeding system according to (2), includes
a cleaning device configured to clean gas in the surrounding member.
(4) The optical power feeding system according to (3), includes
a dust detector configured to detect an amount of dust in the gas in the surrounding member, in which
the cleaning device is caused to operate until the detected amount of dust is equal to or less than a specified value.
(5) The optical power feeding system according to (2), includes
a pressure reducing device configured to reduce a pressure in the surrounding member.
(6) The optical power feeding system according to (5), includes
a pressure detector configured to detect the pressure in the surrounding member, in which
when the detected pressure is not reduced to a specified value as a result of pressure reduction by the pressure reducing device, outputting of the feed light by the light emitter is suppressed.
(7) In the optical power feeding system according to any one of (1) to (6),
the light emitter is a semiconductor laser device in which a semiconductor material of a semiconductor region that exhibits a light-electricity conversion effect is a laser medium for a laser wavelength of 500 nm or shorter.
(8) In the optical power feeding system according to any one of (1) to (7),
the light receiver is a photoelectric conversion element in which a semiconductor material of a semiconductor region that exhibits a light-electricity conversion effect is a laser medium for a laser wavelength of 500 nm or shorter.
(9) Power sourcing equipment performs power feeding to a powered device by spatial transmission of feed light through inside of a surrounding member. The inside serves as a transmission path. The surrounding member is a tubular body. The power sourcing equipment includes
a light emitter configured to output the feed light, a pressure reducing device configured to remove air in the surrounding member, and a pressure detector configured to detect a pressure in the surrounding member, in which
when the pressure in the surrounding member does not reach a specified value or less as a result of pressure reduction by the pressure reducing device, outputting of the feed light is suppressed.
(10) In the power sourcing equipment according to (9),
the light emitter is a semiconductor laser device in which a semiconductor material of a semiconductor region that exhibits a light-electricity conversion effect is a laser medium for a laser wavelength of 500 nm or shorter.

### INDUSTRIAL APPLICABILITY

The present invention is industrially applicable to an optical power feeding system and power sourcing equipment that perform spatial transmission of feed light.

### REFERENCE SIGNS

1, 1A to 1G optical power feeding system
100 first data communication apparatus
110, 110B power sourcing equipment
111 semiconductor laser device for signals (light emitter)
112 feed light
113 optical system
120 transmitter
121 semiconductor laser device for signals
123 laser light
125 signal light
130 receiver
131 photodiode for signals
150B, 150E surrounding member
151 straight pipe
152, 153, 156 joint
154, 155 optical element
161 cleaning device
162 dust detector
163 control device
171 pressure reducing device
172 pressure detector
173 control device
200 optical fiber cable
250 optical fiber
300 second data communication apparatus
310, 310G powered device
311 photoelectric conversion element (light receiver)
320 transmitter
321 semiconductor laser device for signals
323 laser light
325 signal light

1. An optical power feeding system for power feeding from power sourcing equipment to a powered device by spatial transmission of feed light,
the power sourcing equipment comprising:
a light emitter configured to output the feed light,
the powered device comprising:
a light receiver configured to convert the feed light that has been received into electric power,
the optical power feeding system comprising:
a surrounding member surrounding a transmission path of the feed light from the light emitter to the light receiver.

2. The optical power feeding system according to claim 1, wherein the surrounding member is a tubular body inside which the transmission path of the feed light passes.

3. The optical power feeding system according to claim 2, further comprising:
a cleaning device configured to clean gas in the surrounding member.

4. The optical power feeding system according to claim 3, further comprising:
a dust detector configured to detect an amount of dust in the gas in the surrounding member, wherein
the cleaning device is caused to operate until the amount of dust is equal to or less than a specified value.

5. The optical power feeding system according to claim 2, further comprising:
a pressure reducing device configured to reduce a pressure in the surrounding member.

6. The optical power feeding system according to claim 5, further comprising:
a pressure detector configured to detect the pressure in the surrounding member, wherein
when the pressure detected is not reduced to a specified value as a result of pressure reduction by the pressure reducing device, outputting of the feed light by the light emitter is suppressed.

7. The optical power feeding system according to claim 6, wherein the light emitter is a semiconductor laser device in which a semiconductor material of a semiconductor region that exhibits a light-electricity conversion effect is a laser medium for a laser wavelength of 500 nm or shorter.

8. The optical power feeding system according to claim 7, wherein the light receiver is a photoelectric conversion element in which a semiconductor material of a semiconductor region that exhibits a light-electricity conversion effect is a laser medium for a laser wavelength of 500 nm or shorter.

9. Power sourcing equipment for power feeding to a powered device by spatial transmission of feed light through inside of a surrounding member, the inside serving as a transmission path, the surrounding member being a tubular body, the power sourcing equipment comprising:
a light emitter configured to output the feed light;
a pressure reducing device configured to remove air in the surrounding member; and
a pressure detector configured to detect a pressure in the surrounding member, wherein
when the pressure in the surrounding member does not reach a specified value or less as a result of pressure reduction by the pressure reducing device, outputting of the feed light is suppressed.

10. The power sourcing equipment according to claim 9, wherein the light emitter is a semiconductor laser device in which a semiconductor material of a semiconductor region that exhibits a light-electricity conversion effect is a laser medium for a laser wavelength of 500 nm or shorter.
